(19) United States
(12) Patent Application Publication
(10) Pub. No.: US 2023/0290325 A1
(43) Pub. Date: Sep. 14, 2023

(54) SOUND PROCESSING METHOD, SOUND PROCESSING SYSTEM, ELECTRONIC MUSICAL INSTRUMENT, AND RECORDING MEDIUM

(71) Applicant: YAMAHA CORPORATION, Hamamatsu-shi (JP)

(72) Inventor: Kazuhisa AKIMOTO, Hamamatsu-shi (JP)

(21) Appl. No.: 18/320,440

(22) Filed: May 19, 2023

Related U.S. Application Data
(63) Continuation of application No. PCT/JP2021/042690, filed on Nov. 19, 2021.

(30) Foreign Application Priority Data
Nov. 25, 2020 (JP) 2020-194912

(51) Int. Cl. G10H 1/36; G10H 1/00

(52) U.S. Cl. CPC G10H 1/366; G10H 1/0008; G10H 2210/005; G10H 2210/066; G10H 2210/331

(57) ABSTRACT

A computer-implemented sound processing method includes: outputting singing sound data based on a sound signal representing singing sound; and outputting sound data representing musical instrument sound that correlates with musical elements of the singing sound, by inputting input data that includes the singing sound data to a trained model that has learned, by machine learning, a relationship between singing sound for training and musical instrument sound for training.

### CROSS REFERENCE TO RELATED APPLICATIONS

This application is a Continuation Application of PCT Application No. PCT/JP2021/042690 filed on Nov. 19, 2021, and is based on and claims priority from Japanese Patent Application No. 2020-194912, filed on Nov. 25, 2020, the entire contents of each of which are incorporated herein by reference.

### BACKGROUND

### Field of the Invention

This disclosure relates to a technique for outputting musical instrument sound.

There have been proposed a variety of techniques for controlling musical sounds, such as singing sounds and musical instrument sounds. Japanese Patent Application Laid-Open Publication No. JP11-52970 discloses identifying a user's singing style based on user input to a control panel to control sound effects imparted to singing sounds based on the user's singing style.

There is a demand for outputting musical instrument sounds that correlate with user singing sounds. Such correlative musical instrument sounds are output dependent on singing sounds, and include, for example, pitch, rhythm, volume, tone, etc. However, to be able to output such musical instrument sounds a user must have a specialized knowledge of music.

### SUMMARY

In view of the circumstances described above, an object of one aspect of this disclosure is to output musical instrument sounds that correlate with singing sounds without specialized knowledge of music.

To achieve the above-stated object, a computer-implemented sound processing method according to one aspect of this disclosure includes: outputting singing sound data based on a sound signal representing singing sound; and outputting sound data representing musical instrument sound that correlates with musical elements of the singing sound, by inputting input data that includes the singing sound data to a trained model that has learned, by machine learning, a relationship between singing sound for training and musical instrument sound for training.

A computer-implemented sound processing method according to another aspect of this disclosure includes: outputting singing sound data based on a sound signal representing singing sound; and outputting sound data representing musical instrument sound that correlates with musical elements of the singing sound, by inputting input data that includes the singing sound data to a trained model that has trained by machine learning.

A sound processing system according to one aspect of this disclosure includes: at least one memory storing a program; and at least one processor that implements the program to: output singing sound data based on a sound signal representing singing sound; and output sound data representing musical instrument sound that correlates with musical elements of the singing sound, by inputting input data that includes the singing sound data to a trained model that has learned, by machine learning, a relationship between singing sound for training and musical instrument sound for training.

An electronic musical instrument according to one aspect of this disclosure includes: at least one memory storing a program; and at least one processor that implements the program to: output singing sound data based on a sound signal representing singing sound; output sound data representing musical instrument sound that correlates with musical elements of the singing sound, by inputting input data that includes the singing sound data to a trained model that has learned, by machine learning, a relationship between singing sound for training and musical instrument sound for training; and control a sound emitting device to emit performance sound of a piece of music, and musical instrument sound represented by the sound data.

A recording medium according to one aspect of this disclosure is a non-transitory computer readable recording medium storing a program executable by at least one processor to execute a method comprising: outputting singing sound data based on a sound signal representing singing sound; and outputting sound data representing musical instrument sound that correlates with musical elements of the singing sound, by inputting input data that includes the singing sound data to a trained model that has learned, by machine learning, a relationship between singing sound for training and musical instrument sound for training.

### BRIEF DESCRIPTION OF THE DRAWINGS

FIG. 1 is a block diagram showing a configuration of an electronic musical instrument according to a first embodiment.

FIG. 2 is a block diagram showing a functional configuration of the electronic musical instrument.

FIG. 3 is a flow chart showing control procedures.

FIG. 4 is a block diagram showing a configuration of a machine learning system.

FIG. 5 is a diagram illustrative of machine learning.

FIG. 6 is a flow chart showing learning procedures.

FIG. 7 is a block diagram showing a specific configuration of a trained model.

FIG. 8 is a flow chart showing learning procedures according to another aspect.

FIG. 9 is a diagram of first procedures.

FIG. 10 is a block diagram showing a functional configuration of a part of the electronic musical instrument according to the second embodiment.

FIG. 11 is a diagram of how musical instrument sound models N are used in a third embodiment.

FIG. 12 is a block diagram showing a specific configuration of a trained model according to a fourth embodiment.

### DESCRIPTION OF THE EMBODIMENTS

### A: First Embodiment

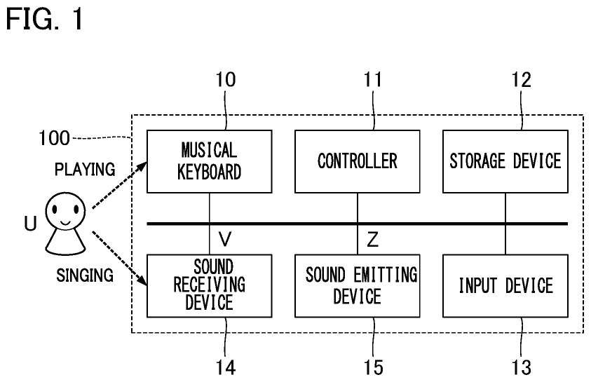

FIG. 1 is a block diagram showing a configuration of an electronic musical instrument 100 according to the first embodiment. The electronic musical instrument 100 is a sound processing system that reproduces sounds based on performance of a user U. The electronic musical instrument 100 includes a musical keyboard 10, a controller 11, a storage device 12, an input device 13, a sound receiving device 14, and a sound emitting device 15. The electronic musical instrument 100 may be implemented by a single device, or may be implemented by more than one device.

Keys of the musical keyboard 10 are operated by the user U. The musical keyboard 10 is an example of a controller, and each of its keys corresponds to a different musical pitch. A time series of pitches corresponding to keys of the musical keyboard 10 is generated by sequential operation of the keys. In the first embodiment, the user U plays the musical keyboard 10 while singing a piece of music. Specifically, the user U sings the piece of music while playing accompaniment on the musical keyboard 10. The played accompaniment may or may not differ from the piece of music that is sung.

The controller 11 comprises one or more processors that control components of the electronic musical instrument 100. Specifically, the controller 11 is constituted of one or more processors, such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 12 comprises one memory or more that stores a program executed by the controller 11 and a variety of types of data used by the controller 11. The storage device 12 may be constituted of a known recording medium, such as a magnetic recording medium or a semiconductor recording medium, or it may be constituted of a combination of more than one type of recording media. Any recording medium, such as a portable recording medium that is attachable to or detachable from the electronic musical instrument 100, or a cloud storage that is accessible by the controller 11 via the network (e.g., the Internet), may be used as the storage device 12.

The input device 13 receives instructions from the user U. The input device 13 may comprise operational input elements (e.g., buttons, sliders, switches) that receive user input, or may be a touch panel that detects user touch input. In response to a user input to the input device 13, a musical instrument is selected from among musical instruments belonging to a same category. Specifically, musical instruments selectable by the user U are categorized as follows: (1) keyboard instrument, (2) bowed string instrument, (3) plucked string instrument, (4) brass wind instrument, (5) woodwind instrument, (6) electronic musical instrument, and so on. In one example, any one of the following types is selectable by the user U: (1) “piano” categorized as a keyboard instrument, (2) “violin” or “cello” categorized as a bowed string instrument, (3) “guitar” or “harp” categorized as a plucked string instrument, (4) “trumpet”, “horn”, or “trombone” categorized as a brass wind instrument, (5) “oboe” or clarinet sound categorized as a woodwind instrument, and (6) “portable keyboard” categorized as an electronic musical instrument.

The sound receiving device 14 is a microphone that receives sound in its vicinity. When the user U sings a piece of music in the vicinity of the sound receiving device 14, the sound receiving device 14 receives the singing sound of the user U to generate a sound signal V representative of a waveform thereof (hereinafter, “singing sound signal”). Description of an analogue-to-digital converter for producing an analog singing sound signal V is omitted here. In the first embodiment, although the sound receiving device 14 is provided integral to the electronic musical instrument 100, an independent sound receiving device may be connected to the electronic musical instrument 100 either by wire or wirelessly. The controller 11 generates a reproduction signal Z representative of a singing sound of the user U.

The sound emitting device 15 emits the singing sound represented by the reproduction signal Z. The sound emitting device 15 may be a loud speaker, headphones, or earphones. Description of a digital-to-analogue converter for producing a digital reproduction signal Z is omitted here. In the first embodiment, although the sound emitting device 15 is provided integral to the electronic musical instrument 100, an independent sound emitting device may be connected to the electronic musical instrument 100 either by wire or wirelessly.

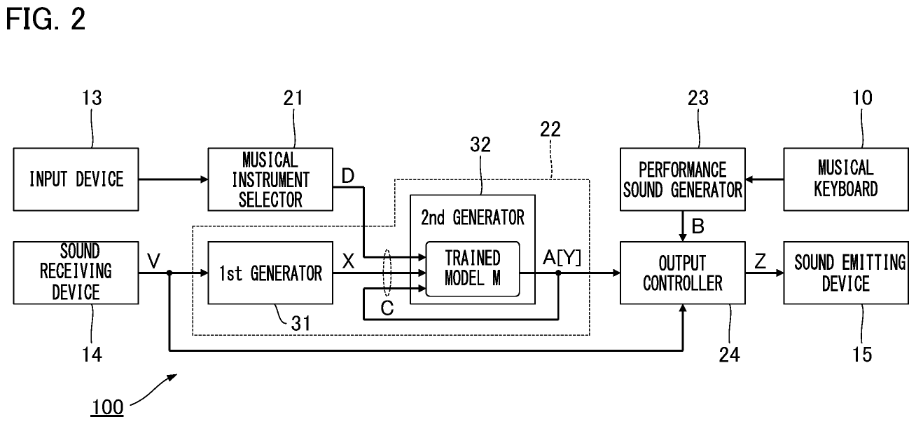

FIG. 2 is a block diagram showing a functional configuration of the electronic musical instrument 100. The controller 11 executes a program stored in the storage device 12, to implement more than one function for generating a reproduction signal Z (a musical instrument selector 21, a sound processor 22, a performance sound generator 23 and an output controller 24). The musical instrument selector 21 receives user instructions for selection of a musical instrument provided by the user U via the input device 13, and generates musical instrument data D that specifies the selected musical instrument. Thus, the musical instrument data D is data that specifies any of the selectable musical instruments.

The sound processor 22 generates a sound signal A based on the singing sound signal V and the musical instrument data D. The sound signal A represents a waveform of sound of the selected musical instrument specified by the musical instrument data D. Musical instrument sound represented by the sound signal A correlates with the singing sound represented by the singing sound signal V

Specifically, pitches of musical instrument sound of the selected musical instrument change in conjunction with those of the singing sound, such that the pitches of the musical instrument sound are substantially the same as those of the singing sound. The sound signal A is generated in parallel with singing by the user U.

The performance sound generator 23 generates a music signal B representative of a waveform of performance sound generated by playing by the user U of the musical keyboard 10. That is, the music signal B is generated in response to sequential operation by the user U of keys of the musical keyboard 10, and represents performance sound with pitches specified by the user U. In the first embodiment, the musical instrument for the performance sound represented by the music signal B may or may not be the same as that of the musical instrument specified by the musical instrument data D. The music signal B may be generated by a sound source circuit that is independent from the controller 11. The music signal B may be stored in advance in the storage device 12. In this case, the performance sound generator 23 may be omitted.

The output controller 24 controls the sound emitting device 15 to emit sound in accordance with each of the singing sound signal V, the sound signal A and the music signal B. Specifically, the output controller 24 generates a reproduction signal Z by synthesizing signals, the singing sound signal V, the sound signal A and the music signal B, and supplies the generated reproduction signal Z to the sound emitting device 15. In one example, the weighted sum of these signals (V, A, and B) is used to generate the reproduction signal Z. Weighted values of these signals (V, A and B) are set in accordance with user instructions provided to the input device 13. Thus, singing sound of the user U (singing sound signal V), a musical instrument sound (sound signal A) of the selected musical instrument that correlates with the singing sound, and performance sound of the user U (music signal B) are emitted in parallel from the sound emitting device 15. The performance sound is the musical instrument sound, and may or may not be the same as that of the musical instrument specified by the musical instrument data D.

As shown in FIG. 2, in the first embodiment, the sound processor 22 includes a first generator 31 and a second generator 32. The singing sound data X is data that represents acoustic features of the singing sound signal V, and includes, for example, a fundamental frequency of a singing sound. The singing sound data X includes features, such as a fundamental frequency of singing sound. The singing sound data X is sequentially generated for each unit time period on the time axis. A length of each unit time period is sufficiently shorter than a musical note (e.g., in the order of micron second). Unit time periods are continuous on the time axis, and may partially overlap.

As shown in FIG. 2, the second generator 32 generates sound data Y based on the singing sound data X and the musical instrument data D. The sound data Y is a time series of samples of a sound signal A within a unit time period. The sound data Y represents a musical instrument sound of the selected musical instrument, a pitch of which changes in conjunction with a change in pitch of the singing sound. Specifically, the second generator 32 generates sound data Y for each unit time period as the singing sound progresses. Thus, a musical instrument sound that correlates with the singing sound is output in parallel with the singing sound. The sound signal A corresponds to a time series of sound data Y over a plurality of unit time periods.

A trained model M is used to generate sound data Y by the second generator 32. Specifically, the second generator 32 inputs input data C to the trained model M for each unit time period to generate sound data Y. The trained model M is a statistical estimation model that has learned a relationship between singing sound and musical instrument sound (a relationship between input data C and sound data Y) by machine learning. The input data C for each unit time period includes singing sound data X within a current unit time period, musical instrument data D, and sound data Y output by the trained model M within an immediately previous unit time period.

The trained model M is a deep neural network (DNN), for example. A type of the deep neural network can be freely selected. For example, a Recursive Neural Network (RNN) or a Convolutional Neural Network (CNN) is used as the trained model M. Additional elements, such as Long Short-Term Memory (LSTM) can be provided in the trained model M.

The trained model M is implemented by a combination of a program executed by the controller 11 to generate sound data Y using input data C, and variables (e.g., weights and biases) used to generate the sound data Y. The program for the trained model M and the variables are stored in the storage device 12. Numerical values of the variables of the trained model M are set in advance by machine learning.

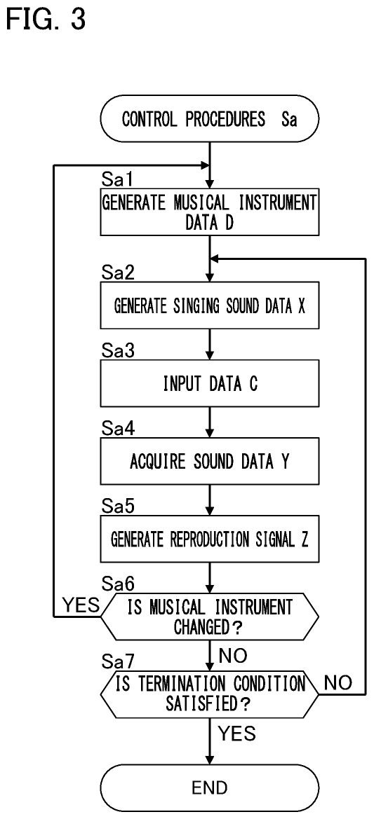

FIG. 3 is a flow chart showing control procedures Sa for generating a reproduction signal Z by the controller 11. The control procedures Sa start in response to a user instruction provided to the input device 13. The user U plays the musical keyboard 10 while singing toward the sound receiving device 14, and the control procedures Sa are carried out. The controller 11 generates a music signal B based on the performance of the user U in parallel with the control procedures Sa.

When the control procedures Sa start, the musical instrument selector 21 generates musical instrument data D representative of a musical instrument selected by the user U (Sa1). Upon receiving a singing sound signal V from the sound receiving device 14, the first generator 31 analyzes a part of the singing sound signal V within a unit time period, and generates singing sound data X (Sa2). The second generator 32 inputs input data C to the trained model M (Sa3). The input data C includes musical instrument data D, singing sound data X, and sound data Y from within an immediately previous unit time period. The second generator 32 acquires sound data Y, which is output by the trained model M for the input data C (Sa4). Thus, the second generator 32 generates sound data Y corresponding to the input data C by using the trained model M. The output controller 24 generates a reproduction signal Z by synthesizing the sound signal A represented by the sound data Y, the singing sound signal V, and the music signal B (Sa5). When the reproduction signal Z is supplied to the sound emitting device 15, the singing sound of the user U and the musical instrument sound generated by the musical keyboard 10, which correlates with the singing sound, are emitted together from the sound emitting device 15.

The musical instrument selector 21 determines whether an instruction to change the selected musical instrument to a different musical instrument is received from the user U (Sa6). When the musical instrument is changed (Sa6: YES), the musical instrument selector 21 generates musical instrument data D that specifies the different musical instrument (Sa1). The same procedures (Sa2 to Sa5) are executed for the different musical instrument. When the musical instrument is not changed (Sa6: NO), the controller 11 determines whether a termination condition is satisfied (Sa7). For example, when an instruction to terminate the control procedures Sa is received by the input device 13, the termination condition is satisfied. When the termination condition is not satisfied (Sa7: NO), the controller 11 advances the current processing to step Sa2. In other words, generation of the singing sound data X (Sa2), generation of the sound data Y (Sa3 and Sa4) using the trained model M, and generation of the reproduction signal Z (Sa5) are repeated for each unit time period. When the termination condition is satisfied (Sa7: YES), the controller 11 terminates the control procedures Sa.

In the first embodiment, the input data C, which includes the singing sound data X corresponding to the singing sound signal V, is input to the trained model M, and thereby the sound data Y representative of a musical instrument sound that correlates with the singing sound is generated. As a result, musical instrument sound that correlates with singing sound can be generated, without need for specialized knowledge of music by the user U.

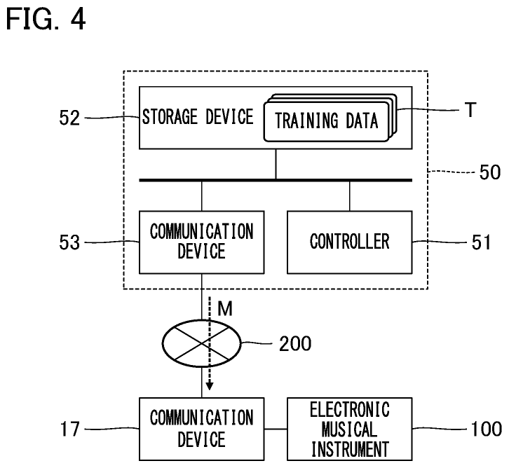

FIG. 4 shows a machine learning system 50 that generates the trained model M. The machine learning system 50 is implemented by a computer system, such as a server apparatus that communicates with a communication device 17 via a network 200 (e.g., the Internet). The communication device 17 is connected to the electronic musical instrument 100 either by wire or wirelessly. The communication device 17 may be user equipment, such as a smartphone or a tablet. The electronic musical instrument 100 communicates with the machine learning system 50 via the communication device 17. The electronic musical instrument 100 may include an integrated communication device that communicates with the machine learning system 50.

The machine learning system 50 includes a controller 51, a storage device 52, and a communication device 53. The machine learning system 50 may be implemented by not only a single computing device but also by plural independent computing devices.

The controller 51 comprises one or more processors that control components of the machine learning system 50. The controller 51 is constituted of one or more processors, such as a CPU, a SPU, a DSP, a FPGA, or an ASIC. The communication device 53 communicates with the communication device 17 via the network 200.

The storage device 52 comprises one memory or more that stores a program executed by the controller 51 and a variety of types of data used by the controller 51. The storage device 52 may be constituted of a known recording medium, such as a magnetic recording medium or a semiconductor recording medium, or it may be constituted of a combination of more than one type of recording medium. Any appropriate recording medium, such as a portable recording medium that is attachable to or detachable from the machine learning system 50, or a cloud storage that is accessible by the controller 51 via the network 200, may be used as the storage device 52.

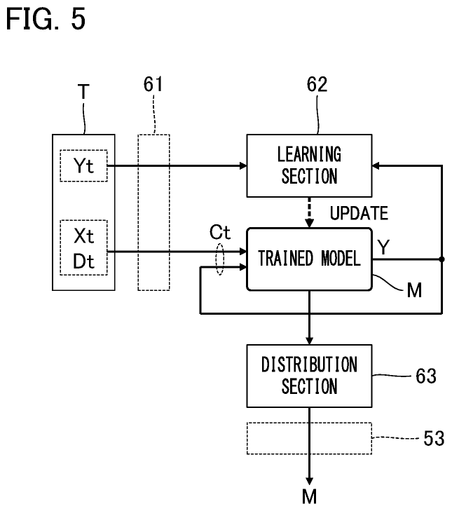

FIG. 5 is a block diagram showing a functional configuration of the machine learning system 50. The controller 51 acts to establish the trained model M by executing a program stored in the storage device 52 (an acquisition section 61, a learning section 62, and a distribution section 63).

The learning section 62 establishes a trained model M by supervised machine learning (learning procedures Sb) using pieces of training data T. The acquisition section 61 acquires pieces of training data T. Specifically, the acquisition section 61 acquires (reads) from the storage device 52 the acquired pieces of training data T. The distribution section 63 distributes (transmits) the trained model M established by the learning section 62 to the electronic musical instrument 100.

The training data T includes singing sound data Xt, musical instrument data Dt and sound data Yt. The singing sound data Xt is used for training as singing sound data X. Specifically, the singing sound data Xt represents acoustic features within a unit time periods of singing sound for training, and is recorded in advance for machine learning of the trained model M. The musical instrument data Dt specifies any of the selectable musical instruments.

The sound data Yt of training data T correlates with singing sound for training represented by the singing sound data Xt of the training data T. The sound data Yt represents musical instrument sounds for training of a musical instrument specified by the musical instrument data Dt of the training data T. Thus, the sound data Yt of a piece of training data T corresponds to a ground truth (label) for the singing sound data Xt and the musical instrument data Dt of the training data T. A pitch of the singing sound for training changes in conjunction with that of the musical instrument sound for training. Specifically, the pitches substantially match each other

The musical instrument sound for training has particular properties specific to the musical instrument. For example, for a musical instrument a pitch of which changes continuously, a change in pitch of the musical instrument sound for training is continuous. For a musical instrument a pitch of which changes discretely, a change in pitch of the musical instrument sound for training is discrete. For a musical instrument a volume of which decreases consistently from a sounding point, a volume from a sounding point of the musical instrument sound for training decreases consistently. For a musical instrument that can maintain a constant sound volume, a volume of the sound of the musical instrument for training is maintained constant. The musical instrument sound for training with particular properties is recorded in advance as sound data Yt.

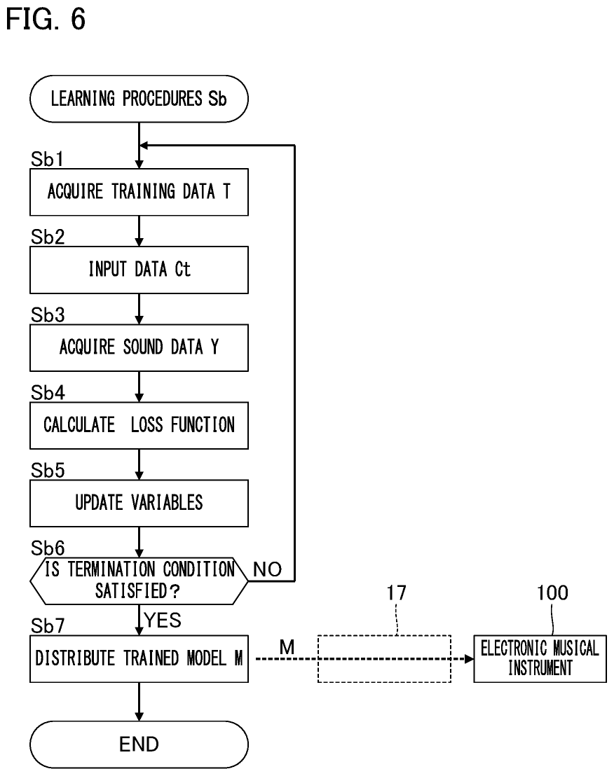

FIG. 6 is a flow chart showing learning procedures Sb for establishing the trained model M by the controller 51. In one example, prior to the control procedures Sa, the learning procedures Sb are initiated in response to a user's instruction provided to the machine learning system 50. The learning procedures Sb comprise one method for generating the trained model M by machine learning.

Upon start of the learning procedures Sb, the acquisition section 61 acquires (reads) a piece of training data T from the storage device 52 that stores the training data T (Sb1). Hereinafter, the acquired training data T is referred to as “selected training data T.” The learning section 62 inputs, to an initial or provisional trained model M, input data Ct corresponding to the selected training data T (Sb2), and acquires sound data Y output by the trained model M in response to the input (Sb3). The input data Ct corresponding to the selected training data T includes (i) singing sound data Xt of the selected training data T, (ii) musical instrument data Dt of the selected training data T, and (iii) sound data Y generated by the trained model M at the previous processing.

The learning section 62 calculates a loss function representative of an error between the sound data Y acquired from the trained model M and the sound data Yt of the selected training data T (Sb4). Then, the learning section 62 updates variables of the trained model M so that the loss function is reduced (ideally, minimized), as shown in FIG. 4 (Sb5). In one example, an error back propagation method is used to update variables of the loss function.

The learning section 62 determines whether a termination condition is satisfied (Sb6). The termination condition may be defined by the loss function below a threshold, or may be defined by an amount of change in the loss function below a threshold. When the termination condition is not satisfied (Sb6: NO), the acquisition section 61 reads out new training data T that has not yet been selected (Sb1). Thus, until the termination condition is satisfied (Sb6: YES), updating of the variables of the trained model M (Sb2 to Sb5) is repeated. When the termination condition is satisfied (Sb6: YES), the learning section 62 terminates the updating of the variables (Sb2 to Sb5). The variables of the trained model M are set as numerical values at the end of the learning procedures Sb.

Under a potential relationship between (i) input data Ct (singing sound for training) corresponding to a piece of training data T and (ii) sound data Yt (musical instrument sound for training), statistically reasonable sound data Y for unknown input data C is output by the trained model M. Thus, the trained model M is obtained by learning a relationship between singing sound for training and musical instrument sound for training, using machine learning.

The distribution section 63 distributes the trained model M established by the procedures described above to the communication device 17 (Sb7). Specifically, by the distribution section 63, the variables of the trained model M are distributed (transmitted) from the communication device 53 to the communication device 17. In response to receipt of the trained model M from the machine learning system 50 via the network 200, the communication device 17 transfers the trained model M to the electronic musical instrument 100. The trained model M received by the communication device 17 (i.e., the variables of the trained model M) is stored in the storage device 12 of the electronic musical instrument 100 under control of the controller 11. The sound processor 22 generates a sound signal A using the trained model M, which is defined by the variables stored in the storage device 12. The trained model M may be stored in a recording medium provided in the communication device 17. In this case, the sound processor 22 of the electronic musical instrument 100 generates a sound signal A by using the trained model M stored in the communication device 17.

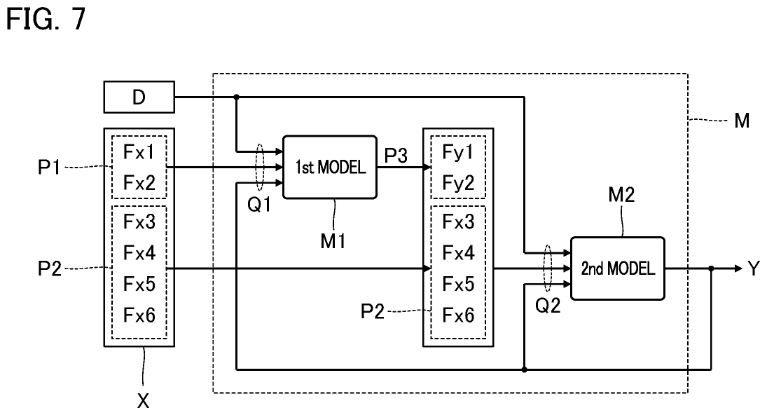

FIG. 7 is a block diagram showing a specific configuration of the trained model M according to the first embodiment. Singing sound data X to be input to the trained model M includes features Fx (Fx1 to Fx6) relating to singing sound. The features Fx include a pitch Fx1, an onset Fx2, an error Fx3, a duration Fx4, an inflection (intonation) Fx5, and a timbre change Fx6.

The pitch Fx1 represents a fundamental frequency of a pitch of the singing sound within a unit time period. The onset Fx2 represents a start time point of a note or a phoneme on the time axis. Specifically, the onset Fx2 corresponds to a beat point closest to a note of the singing sound at a subject time point. The onset Fx2 may correspond either to a normal or defining beat point in the piece of music. In one example, the onset Fx2 represents a time point relative to a predetermined time point, such as a start time point of a sound signal A within a unit time period. The onset Fx2 may be indicated by a flag that represents whether a subject unit time period corresponds to a start time point of a note of the singing sound.

The error Fx3 represents a temporal time error relating to a start time point of a note of the singing sound. In one example, the error Fx3 corresponds to a time difference between a subject time point and a normal or defining beat point in the piece of music. The duration Fx4 represents a time length during which a note of the singing sound continues. The duration Fx4 for a unit time period may represent a time length during which the singing sound continues within the unit time period. The inflection Fx5 represents a temporal change in a volume of the singing sound or a pitch thereof. The inflection Fx5 may represent a time series of volumes or pitches within a unit time period. Alternatively, the inflection Fx5 may represent a rate of change in a volume within the unit time period, or a range of variation of the sound volume. The timbre change Fx6 represents a temporal change in frequency response of the singing sound. The timbre change Fx6 may represent a time series of indicators, such as frequency spectrums or MFCCs (Mel-Frequency Cepstrum Coefficients) of the singing sound.

The singing sound data X includes first data P1 and second data P2. The first data P1 includes a pitch Fx1 and an onset Fx2. The second data P2 includes an error Fx3, a duration Fx4, an inflection Fx5, and a timbre change Fx6, which differ from the features of the first data P1. The first data P1 represents musical content of the singing sound, which is basic information. The second data P2 represents musical expression of the singing sound, which is supplemental or additional information. The onset Fx2 included in the first data P1 may correspond to a standard rhythm defined by a score of a piece of music. The error Fx3 included in the second data P2 may correspond to a variation of a rhythm reflected by the user U as a musical expression of the singing sound (variation in the rhythm as musical expression).

The trained model M according to the first embodiment includes a first model M1 and a second model M2. The first and second models M1 and M2 each are comprised of DNN, such as RNN or CNN. The first model M1 may be or may not be the same type as the second model M2.

The first model M1 is a statistical estimation model that has learned a relationship between first intermediate data Q1 and third data P3 by machine learning. The first model M1 outputs the third data P3 in response to receipt of the first intermediate data Q1. The second generator 32 generates third data P3 by inputting the first intermediate data Q1 to the first model M1.

Specifically, the first model M1 is implemented by a combination of the following: (i) a program executed by the controller 11 to generate third data P3 using the first intermediate data Q1, and (ii) variables used in the generation of the third data P3 (i.e., weighted values and biases). Numerical values of the variables of the first model M1 are set by the learning procedures Sb.

The first intermediate data Q1 is input to the first model M1 for each unit time period. The first intermediate data Q1 in each unit time period includes first data P1 of the singing sound data X within a unit time period, musical instrument data D, and sound data Y output by the trained model M (second model M2) within an immediately previous unit time period. The first intermediate data Q1 within each unit time period may include second data P2 of the singing sound data X within the unit time period.

The third data P3 includes a pitch Fy1 of a musical instrument sound of a musical instrument specified by the musical instrument data D, and an onset Fy2. The pitch Fy1 represents a fundamental frequency of a pitch of a singing sound within a unit time period. The onset Fy2 represents a start time point of a note of a musical instrument sound on the time axis. The pitch Fy1 of the musical instrument sound correlates with a pitch Fx1 of the singing sound. The onset Fy2 of the musical instrument sound correlates with an onset Fx2 of the singing sound. Specifically, the pitch Fy1 of the musical instrument sound is identical to (or approximates) the pitch Fx1 of the singing sound. The onset Fy2 of the musical instrument sound is identical to (or approximates) the onset Fx2 of the singing sound. However, the pitch Fy1 and the onset Fy2 of the musical instrument sound depend on features inherent to a selected musical instrument. For example, a change in the pitch Fy1 depends on the selected musical instrument. An onset Fy2 is not necessarily identical to the onset Fx2.

The first model M1 is a trained model that has learned a relationship between first data P1 (a pitch Fx1 and an onset Fx2 of a singing sound) and third data P3 (a pitch Fy1 and an onset Fy2 of a musical instrument sound). First intermediate data Q1 may include first data P1 and second data P2 of the singing sound data X.

The second model M2 is a statistical estimation model that has learned a relationship between second intermediate data Q2 and sound data Y by machine learning. The second model M2 outputs the sound data Y in response to receipt of the second intermediate data Q2. The second generator 32 inputs the second intermediate data Q2 to the second model M2 to generate the sound data Y. A combination of the first intermediate data Q1 and the second intermediate data Q2 corresponds to input data C shown in FIG. 2.

The second model M2 is implemented by a combination of the following: (i) a program executed by the controller 11 to generate sound data Y using the second intermediate data Q2, and (ii) variables used in the generation of the sound data Y (i.e., weights and biases). Numerical values of the variables of the second model M2 are set by the learning procedures Sb.

The second intermediate data Q2 includes second data P2 of the singing sound data X, third data P3 generated by the first model M1, musical instrument data D, and sound data Y output by the trained model M (second model M2) within the immediately previous unit time period. The sound data Y output by the second model M2 represents a musical instrument sound reflected as musical expression represented by the second data P2. The musical expression inherent to the selected musical instrument specified by the musical instrument data D is imparted to the musical instrument sound represented by the sound data Y. In other words, the features Fx included in the second data P2 (i.e., an error Fx3, a duration Fx4, an inflection Fx5, and a timbre change Fx6) is converted into musical expression that can be executed by the selected musical instrument, and is reflected in the sound data Y.

When the selected musical instrument is a keyboard instrument (e.g., “piano”), crescendo, decrescendo or other similar musical expressions are imparted to the musical instrument sound in accordance with an inflection Fx5 of the singing sound. In addition, legato, staccato, sustain or similar musical expressions are imparted to the musical instrument sound in accordance with a duration Fx4 of the singing sound.

When the selected musical instrument is a bowed stringed instrument (e.g., “violin” or “cello”), vibrato, tremolo or similar musical expressions are imparted to the musical instrument sound in accordance with an inflection Fx5 of the singing sound. Spiccato or similar musical expressions may be imparted to the musical instrument sound in accordance with a duration Fx4 or a timbre change Fx6 of the singing sound.

When the selected musical instrument is a plucked string instrument (e.g., “guitar” and “harp”), choking or similar musical expressions are imparted to the musical instrument sound in accordance with an inflection Fx5 of the singing sound. In addition, slap or similar musical expressions are imparted to the musical instrument sound in accordance with a duration Fx4 and a timbre change Fx6 of the singing sound.

When the selected musical instrument is brass instrument (e.g., “trumpet,” “horn” or “trombone”), vibrato, tremolo or similar musical expressions are imparted to the musical instrument sound in accordance with an inflection Fx5 of the singing sound. Tonguing or other similar musical expressions may be imparted to the musical instrument sound in accordance with a duration Fx4 of the singing sound.

When the selected musical instrument is a woodwind instrument (e.g., “oboe” and “clarinet”), vibrato, tremolo or similar musical expressions are imparted to the musical instrument sound in accordance with an inflection Fx5 of the singing sound. In addition, tonguing or similar musical expressions are imparted to the musical instrument sound in accordance with a duration Fx4 of the singing sound. Furthermore, sub tone, growl tone, or similar musical expressions are imparted to the musical instrument sound in accordance with a timbre change Fx6 of the singing sound.

In the foregoing description of the first embodiment, a musical instrument sound of the selected musical instrument specified by the musical instrument data D is generated from among a plurality of musical instruments. As a result, a variety of musical instrument sounds that correlate with singing sounds of the user U can be generated. In addition, sound data Y representative of musical instrument sound with an appropriate pitch Fx1 and onset Fx2 of the singing sound can be generated with high accuracy because singing sound data X includes features Fx, which include a pitch Fx1 and an onset Fx2 of the singing sound.

In the first embodiment, the trained model M includes a first model M1 and a second model M2. In response to receipt of first intermediate data Q1, which includes a pitch Fx1 and an onset Fx2 of the singing sound, the first model M1 outputs third data P3, which includes a pitch Fy1 and an onset Fy2 of a musical instrument sound. In response to receipt of second intermediate data Q2, which includes second data P2 representative of musical expression of the singing sound and third data P3 of the musical instrument sound, the second model M2 outputs sound data Y. Thus, two independent models are provided: a first model M1 that processes basic information on the singing sound (pitch Fx1 and onset Fx2), and a second model M2 that processes information relating to musical expression of the singing sound (error Fx3, duration Fx4, inflection Fx5 and timbre change Fx6). As a result, the sound data Y representative of an appropriate musical instrument sound for a singing sound can be generated with high accuracy.

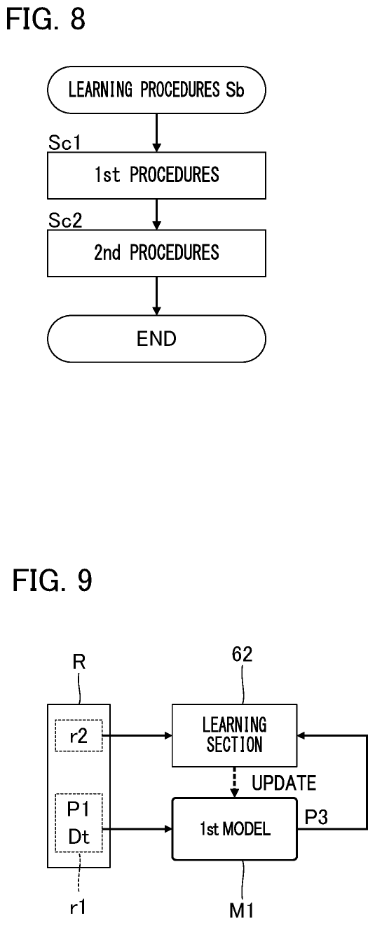

In the first embodiment, the first model M1 and the second model M2 of the trained model M are established together by the learning procedures Sb shown in FIG. 6. However, each of the first and second models M1 and M2 may be established independently by different machine learning. In one example, as shown in FIG. 8, the learning procedures Sb may include first procedures Sc1 and second procedures Sc2. The first model M1 is established by the first procedures Sc1 using machine learning. The second model M2 is established by the second procedures Sc2 using machine learning.

As shown in FIG. 9, the first procedures Sc1 uses pieces of training data R. Each of the pieces of training data R comprises a combination of input data r1 and output data r2. The input data r1 includes first data P1 of singing sound data Xt, and musical instrument data Dt. By the first procedures Sc1, the learning section 62 calculates a loss function representing an error between: (i) third data P3 generated by the initial or provisional first model M1 using the input data r1 of training data R, and (ii) output data r2 of the training data R. The learning section 62 then updates the variables of the first model M1 such that the loss function is reduced. The first model M1 is established by repeating these procedures for each of the pieces of training data Rs.

In the second procedures Sc2, the same procedures as those of the learning procedures Sb shown in FIG. 6 are executed. However, in the second procedures Sc2, the learning section 62 updates the variables of the second model M2 with the variables of the first model M1 fixed. As described above, the trained model M includes the first and second models M1 and M2, and thereby the machine learning can be implemented independently for each of the two models. The variables of the first model M1 may be updated in the second procedures Sc2.

### B: Second Embodiment

The second embodiment will now be described. In the embodiments described below, like reference signs are used for elements that have functions or effects that are the same as those of elements described in the first embodiment, and detailed explanation of such elements is omitted as appropriate.

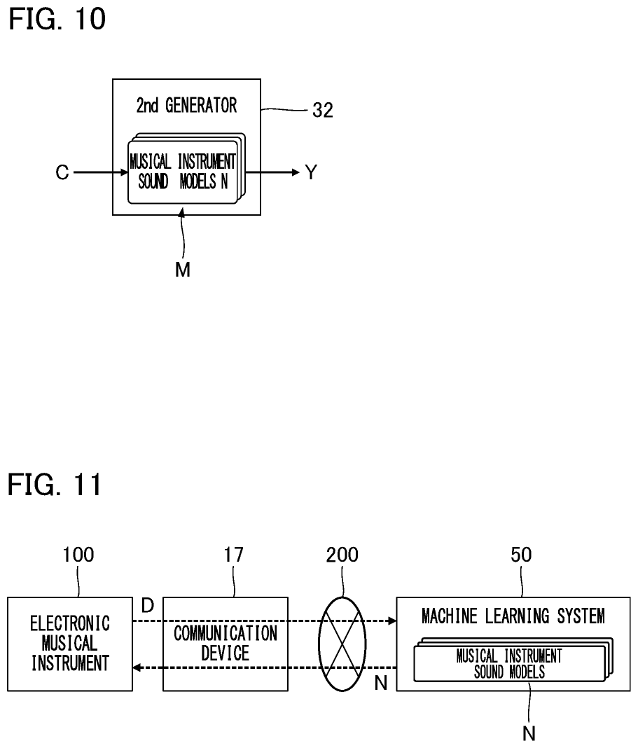

FIG. 10 is a block diagram showing a functional configuration of a part of the electronic musical instrument 100 according to the second embodiment. The trained model M according to the second embodiment includes musical instrument sound models N, each corresponding to a different musical instrument. Each musical instrument sound model N is a statistical estimation model that has learned, by machine learning, a relationship between a musical instrument sound of a musical instrument and a singing sound. Specifically, each musical instrument sound model N outputs sound data Y representative of a musical instrument sound of a musical instrument in response to receipt of input data C. However, in the second embodiment, the input data C does not include musical instrument data D. That is, the input data C within a unit time period includes singing sound data X, and an immediately previous unit time period sound data Y.

The second generator 32 inputs the input data C to any of the musical instrument sound models N, to generate sound data Y representative of a musical instrument sound of a musical instrument that corresponds to the musical instrument sound model N. Specifically, from among the musical instrument sound models N, the second generator 32 selects a musical instrument sound Model N that corresponds to a selected musical instrument specified by the musical instrument data D. The second generator 32 then generates sound data Y, by inputting the input data C to the musical instrument sound model N. As a result, the sound data Y representative of the musical instrument sound of the musical instrument selected by the user U is generated.

The musical instrument sound models N are established by the learning procedures Sb similar to those of the first embodiment. In this case, the musical instrument data D is omitted from each piece of training data T. Furthermore, each musical instrument model N includes a first model M1 and a second model M2. In this case, the first and second intermediate data Q1 and Q2 are omitted from the musical instrument data D.

The second embodiment provides the same effect as the first embodiment. Furthermore, in the second embodiment the sound data Y can be generated by using any of the musical instrument sound models N. As a result, a variety of musical instrument sounds that correlate with singing sound can be generated.

### C: Third Embodiment

In the third embodiment, any of the musical instrument sound models N can be used in a manner similar to the second embodiment. FIG. 11 is a diagram showing how the musical instrument sound models N are used in the third embodiment. The electronic musical instrument 100 according to the third embodiment communicates with the machine learning system 50 via the communication device 17 (e.g., a smartphone or a tablet), in a manner similar to the example shown in FIG. 4. The musical instrument sound models N generated by the learning procedures Sb are stored in the machine learning system 50. Specifically, variables of each musical instrument sound model N are stored in the storage device 52.

The musical instrument selector 21 of the electronic musical instrument 100 generates musical instrument data D that specifies the selected musical instrument, and transmits the generated musical instrument data D to the communication device 17. The communication device 17 transmits the musical instrument data D received from the electronic musical instrument 100 to the machine learning system 50. In response to receipt of the musical instrument data D from the communication device 17, the machine learning system 50 selects, from among the musical instrument sound models N, a musical instrument sound model N that corresponds to the selected musical instrument specified by the received musical instrument data D, and transmits the selected musical instrument sound model N to the communication device 17. The musical instrument sound model N transmitted from the machine learning system 50 is stored in the communication device 17. The sound processor 22 of the electronic musical instrument 100 generates a sound signal A using the musical instrument sound model N stored in the communication device 17. The musical instrument sound model N received from the communication device 17 may be transferred to the electronic musical instrument 100. After a musical instrument sound model N is stored in the electronic musical instrument 100 or the communication device 17, no further communication with the machine learning system 50 is required.

The third embodiment provides the same effect as those of the first and second embodiments. Furthermore, in the third embodiment any of the musical instrument sound models N generated by the machine learning system 50 can be provided to the electronic musical instrument 100. As a result, it is not necessary for the electronic musical instrument 100 or the communication device 17 to store all of the musical instrument sound models N. As will be clear from the description of the third embodiment, not all of the musical instrument sound models N (the trained learned model M) generated by the machine learning system 50 need be provided to the electronic musical instrument 100 or the communication device 17. Rather, only musical instrument sound models N (the trained model M) that are used in the electronic musical instrument 100 are provided to the electronic musical instrument 100.

### D: Fourth Embodiment

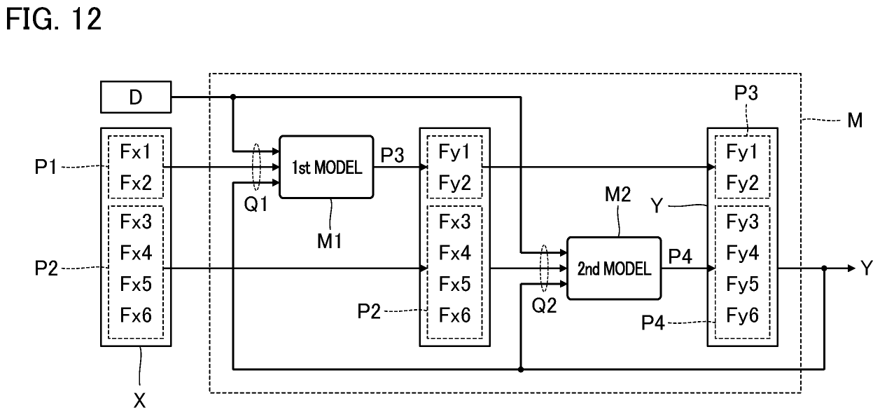

FIG. 12 is a block diagram showing a specific configuration of a trained model M according to the fourth embodiment. Sound data Y according to the fourth embodiment includes features Fy (Fy1 to Fy6) relating to musical instrument sound. The features Fy include a pitch Fy1, an onset Fy2, an error Fy3, a duration Fy4, an inflection (intonation) Fy5, and a timbre change Fy6. The pitch Fy1 and the onset Fy2 are the same as those described in the first embodiment. The error Fy3 represents a temporal time error relating to a start time point of a note of the musical instrument sound. The duration Fy4 represents a time length during which a note of the musical instrument sound continues. The inflection Fy5 represents a temporal change in a pitch or volume of the musical instrument sound. The timbre change Fx6 represents a temporal change in a frequency response of the musical instrument sound.

The sound data Y according to the fourth embodiment includes third data P3 and fourth data P4. The third data P3 represents musical content of the musical instrument sound, which is basic information, and includes a pitch Fy1 and an onset Fy2, similar to the first embodiment. The fourth data P4 represents musical expression of the musical instrument sound, which is supplemental or additional information. The fourth data P4 includes features Fy (an error Fy3, a duration Fy4, an inflection Fy5 and a timbre change Fy6), which differ from the features of the first data P1 and the third data P3.

In the fourth embodiment, the trained model M includes a first model M1 and a second model M2 in similar to those of the first embodiment. The first model M1 is a statistical estimation model that has learned a relationship between the first intermediate data Q1 and the third data P3 by machine learning. The first model M1 outputs the third data P3 in response to receipt of the first intermediate data Q1.

The second model M2 according to the fourth embodiment is a statistical estimation model that has learned a relationship between the second intermediate data Q2 and the fourth data P4 by machine learning. That is, the second model M2 outputs the fourth data P4 in response to receipt of the second intermediate data Q2. The second generator 32 outputs the fourth data P4 by inputting the second intermediate data Q2 to the second model M2. Sound data Y, which includes the third data P3 output by the first model M1 and the fourth data P4 output by the second model M2, is output from the trained model M.

The second generator 32 according to the fourth embodiment generates a sound signal A using the sound data Y output by the trained model M. Accordingly, the sound signal A generated by the second generator 32 represents a musical instrument sound with features Fy included in the sound data Y. Known techniques can be used for the generation of the sound signal A. Procedures and configurations of the second generator 32 are the same as those of the first embodiment.

The fourth embodiment provides the same effects as those of the first embodiment. As will be apparent from the description of the first and fourth embodiments, the sound data Y represents musical instrument sound. The concept of the sound data Y includes data representative of features Fy of the musical instrument sound (refer to the fourth embodiment) in addition to data representative of a waveform of the musical instrument sound (refer to the first embodiment).

### E: Modifications

Specific modifications applicable to each of the aspects described above are set out below. More than one mode selected from the following descriptions may be combined, as appropriate, as long as such combination does not give rise to any conflict.

(1) In the foregoing embodiments, sound data Y output by the trained model M is returned to the input (input data C). However, the return of the sound data Y may be omitted. That is, the input data C (first intermediate data Q1, second intermediate data Q2) may include no sound data Y.

(2) In the foregoing embodiments, any one of the musical instruments can be used to generate a musical instrument sound; however, a single musical instrument sound only may be used. In this case, sound data Y may represent a musical instrument sound of a single musical instrument only. The musical instrument selector 21 and the musical instrument data D in each embodiment may be omitted.

(3) In the foregoing embodiments, a sound signal A and a music signal B representative of a performance of the user U are synthesized by the output controller 24. However, the synthesis function of the output controller 24 may be omitted. If the synthesis function is omitted, the musical keyboard 10 and the performance sound generator 23 may also be omitted. Furthermore, in the foregoing embodiments, a sound signal A and a singing sound signal V representative of a singing sound are synthesized by the output controller 24. However, the synthesis function of the output controller 24 may be omitted. In this case, it is sufficient for the output controller 24 to cause the sound emitting device 15 to emit a musical instrument sound represented by the sound signal A. The synthesis of the sound signal A and the music signal B or the synthesis of the sound signal A and the singing sound signal V may be omitted.

(4) In the foregoing embodiments, a musical instrument is selected by the musical instrument selector 21 in accordance with an instruction provided by a user. However, a method for selecting a musical instrument by the musical instrument selector 21 is not limited to such an example. A random musical instrument may be selected by the musical instrument selector 21. Musical instruments may be selected one by one by the musical instrument selector 21 as a singing sound progresses.

(5) In the foregoing embodiments, the generated sound data Y represents a musical instrument sound a pitch of which changes in conjunction with that of singing sound. However, a relationship between the singing sound and the musical instrument sound is not limited to such an example. In one example, the sound data Y may represent a musical instrument sound with a pitch that satisfies a predetermined relationship between the pitch of the musical instrument sound and a pitch of the singing sound. In one example, the predetermined relationship may be a relationship in which a predetermined pitch difference (e.g., a perfect 5^{th}) exists between the pitch of the musical instrument sound and the pitch of the singing sound. Thus, the pitch of the musical instrument sound is not necessarily identical to the pitch of the singing sound. The foregoing embodiments are described in terms of generation of sound data Y representative of musical instrument sound with pitch that is the same as (or similar to) a pitch of the singing sound. The sound data Y generated by the sound processor 22 may represent a musical instrument sound a volume of which changes depending on a volume of a singing sound, or may represent a musical instrument sound a tone of which changes depending on a tone of the singing sound. The sound data Y generated by the sound processor 22 may represent a musical instrument sound a rhythm of which is synchronized with a rhythm of the singing sound (a timing of each note of the singing sound).

As will be apparent from the examples, the sound processor 22 is comprehensively described as an element that generates sound data Y representative of musical instrument sounds that correlate with singing sounds. Specifically, the sound processor 22 generates sound data Y representing musical instrument sound correlative with musical elements of singing sound (e.g., music instrument sound generated dependent on the musical elements of the singing sound). The musical elements are musical factors related to sound (singing or music instrument sound). Such musical elements include pitch, volume, timbre, rhythm and temporal variations (e.g., inflection of pitches and volumes).

(6) In the foregoing embodiments, an example is given of singing sound data X including features Fx extracted from a singing sound signal V. However, information included in the singing sound data X is not limited to such an example. The first generator 31 may generate, as the singing sound data X, a time series of samples constituting a part of the singing sound signal V within a unit time period. Thus, the singing sound data X is comprehensively described as data corresponding to the singing sound signal V.

(7) In the foregoing embodiments, the trained model M is established by the machine learning system 50, which is independent from the electronic musical instrument 100. However, functions for establishing the trained model M by the learning procedures Sb that use pieces of training data T may be provided in the electronic musical instrument 100. In this case, the acquisition section 61 and the learning section 62 shown in FIG. 5 may be implemented by the controller 11 of the electronic musical instrument 100.

(8) In the foregoing embodiments, an example is given of the DNN as the trained model M, but the trained model M is not limited to the DNN. A statistical estimation model, such as Hidden Markov Model (HMM) or Support Vector Machine (SVM) may be used as the trained model M. Furthermore, an example is given of the supervised machine learning using the pieces of training data T, as the learning procedures Sb. However, the trained model M may be established by unsupervised machine learning, which does not use training data T.

(9) In the foregoing embodiments, the trained model M is used, which has learned a relationship between singing sound and musical instrument sound (a relationship between input data C and sound data Y). However, configurations of and procedures for generating the sound data Y depending on the input data C are not limited to such an example. The second generator 32 may generate sound data Y using a data table in which there is a correspondence between the input data C and the sound data Y (hereinafter, “reference table”). The reference table is stored in the storage device 12. The second generator 32 searches the reference table for the input data C including singing sound data X generated by the first generator 31 and musical instrument data D generated by the musical instrument selector 21. Such a configuration provides the same effects as those provided by the embodiments. The generation of the sound data Y by using the trained model M or the reference table is comprehensively described as generation of the sound data Y by using the input data C that includes the singing sound data X.

(10) The computer system that includes a sound processor 22 according to the foregoing embodiments is described as a sound processing system. The sound processing system for receiving performance of the user U corresponds to the electronic musical instrument 100 described in the embodiments. The musical keyboard 10 may be, or may not be provided in the sound processing system.

(11) The sound processing system may be implemented by a server apparatus that communicates with user equipment (e.g., a mobile phone or smartphone). In this case, the sound processing system generates sound data Y using a singing sound signal V and musical instrument data D received from the user equipment, and transmits the generated sound data Y (or a sound signal A) to the user equipment.

(12) The functions of the electronic musical instrument 100 according the foregoing embodiments are implemented by cooperation of one or more processors, which comprises the controller 11, and a programs stored in the storage device 12. The program may be provided by being pre-recorded on a computer-readable recording medium, and it may be installed in a computer. For example, the computer-readable recording medium may be a non-transitory recording medium, examples of which include an optical recording medium (optical disk), such as a CD-ROM. The computer-readable recording medium may be a known recording medium, such as a semiconductor recording medium, or a magnetic recording medium. The non-transitory recording medium includes any recording medium excluding a transitory propagating signal, and a volatile recording medium is not excluded. When programs are distributed by a distribution device via a network, a storage device included in the distribution device corresponds to a non-transient recording medium described above.

### F: Appendices

The following configurations are derivable from the foregoing embodiments.

A computer-implemented sound processing method according to one aspect (Aspect 1) of this disclosure includes: generating singing sound data based on a sound signal representing singing sound; and generating sound data representing musical instrument sound that correlates with musical elements of the singing sound, by inputting input data that includes the singing sound data to a trained model that has learned, by machine learning, a relationship between singing sound for training and musical instrument sound for training.

According to this aspect, the input data, which includes the singing sound data based on the sound signal of the singing sound, is input to the trained model, thereby generating the sound data representative of the musical instrument sound that correlates with the singing sound. As a result, musical instrument sound that correlates with singing sound can be generated without specialized knowledge of music.

The singing sound data is any data that is based on a sound signal representative of a singing sound. In one example, the singing sound data may be data representative of one or more features relating to the singing sound, or may be a time series of samples of a sound signal representative of a waveform of the singing sound. The sound data is a time series of samples constituting the sound signal representative of a waveform of a musical instrument sound, or represents one or more features relating to the musical instrument sound.

The musical instrument sound that correlates with the singing sound is generated in parallel with the singing sounds. Typically, the musical instrument sound is a melody in common with or similar to the singing sound. However, the musical instrument sound may be melody that is harmonized with the singing sound, or may be an accompaniment to the singing sound.

A computer-implemented sound processing method according to another aspect of this disclosure includes: generating singing sound data based on a sound signal representing singing sound; and generating sound data representing musical instrument sound that correlates with musical elements of the singing sound by inputting input data that includes the singing sound data to a trained model that has trained by machine learning.

According to this aspect, the input data, which includes the singing sound data based on the sound signal of the singing sound, is input to the trained model, thereby generating the sound data representative of the musical instrument sound that correlates with the singing sound. As a result, musical instrument sound that correlates with singing sound can be generated without specialized knowledge of music.

In a specific example (Aspect 2) according to Aspect 1, the generating generates the sound data in parallel with progress of the singing sound.

According to this aspect, the sound data is generated in parallel with progress of the singing sound. That is, musical instrument sound that correlates with singing sound can be played back together with the singing sound.

In a specific example (Aspect 3) according to Aspect 1 or 2, the sound data represents a pitch of the musical instrument sound that changes in accordance with a pitch of the singing sound.

Furthermore, in a specific example (Aspect 4) according to Aspect 1 or 2, the sound data represents a pitch of the musical instrument sound that satisfies a relationship where a predetermined pitch difference exists between the pitch of the musical instrument sound and a pitch of the singing sound.

In a specific example (Aspect 5) according to any one of Aspects 1 to 4, the input data includes known sound data generated by the trained model. According to this aspect, suitable sound data can be generated based on a relationship between a series of sound data.

In a specific example (Aspect 6) according to any one of Aspects 1 to 5, the input data includes musical instrument data that specifies a first musical instrument from among a plurality of musical instruments, and the sound data represents musical instrument sound of the first musical instrument specified by the musical instrument data.

In this aspect, from among the musical instruments, a musical instrument sound of the musical instrument specified by the musical instrument data is generated. As a result, a variety of types of musical instrument sound that correlates with the singing sound can be generated. In one example, the musical instrument specified by the musical instrument data is a musical instrument selected by the user or a musical instrument that is played by the user.

In a specific example (Aspect 7) according to Aspect 6, adding the following signals: the sound signal representing the singing sound; a time series signal of the sound data; and a signal representing musical instrument sound of a second musical instrument that differs from the first musical instrument.

According to this aspect, it is possible to generate (reproduce) a variety of sounds including singing sound, musical instrument sound that correlates with the singing sound, and musical instrument sound of a different musical instrument.

In a specific example (Aspect 8) according to any one of Aspects 1 to 7, the singing sound data includes a plurality of features relating to the singing sound, and the plurality of features include: pitch of the singing sound; and an onset of the singing sound.

According to this aspect, the singing sound includes features that have a pitch and an onset. As a result, sound data representative of appropriate musical instrument sound for the pitch of the singing sound and the onset of the singing sound can be generated with high accuracy. The onset of the singing sound is a start time of output of the singing sound. For example, the onset corresponds to a beat point closest to a note of the singing sound at a subject time point.

In a specific example (Aspect 9) according to Aspect 1, the sound processing method further includes providing the trained model. The singing data includes: (i) first data including: a pitch of the singing sound; and an onset of the singing sound; and (ii) second data including a feature that relates to the singing sound and differs from the pitch and onset of the singing sound. The trained model includes: (i) a first model that outputs third data in response to receipt of first intermediate data that includes the first data, the third data including: (a) a pitch of the musical instrument sound; and (b) an onset of the musical instrument sound, and (ii) a second model that outputs the sound data in response to receipt of second intermediate data that includes the second data and the third data.

According to this aspect, the trained model includes the first model and the second model. As a result, sound data representative of a musical instrument sound appropriate for a singing sound can be generated with high accuracy.

In a specific example (Aspect 10) according to Aspect 1, the sound processing method further includes the trained mode. The singing data includes: (i) first data including: a pitch of the singing sound; and an onset of the singing sound; (ii) second data including a feature that relates to the singing sound and differs from the pitch and onset of the singing sound. The trained model includes: (i) a first model that outputs third data in response to receipt of first intermediate data that includes the first data, the third data including: (a) a pitch of the musical instrument sound; and (b) an onset of the musical instrument sound, and (ii) a second model that outputs fourth data in response to receipt of second intermediate data that includes the second data and the third data, the fourth data including a feature that relates to the musical instrument sound and differs from the pitch and onset of the singing sound. The sound data includes the third data and the fourth data.

According to this aspect, the trained model includes the first model and the second model. As a result, sound data representative of a musical instrument sound appropriate for a singing sound can be generated with high accuracy.

In a specific example (Aspect 11) according to Aspect 9 or 10, the first intermediate data includes musical instrument data that specifies a musical instrument.

In a specific example (Aspect 12) according to Aspect 11, the second intermediate data includes the musical instrument data.

In a specific example (Aspect 13) according to any one of Aspects 9 to 12, the first intermediate data includes known sound data.

In a specific example (Aspect 14) according to any one of Aspects 9 to 13, the second intermediate data includes known sound data.

According to Aspects 13 or 14, suitable sound data can be generated based on a relationship between a series of sound data.

In a specific example (Aspect 15) according to any one of Aspects 8 to 14, the plurality of features further include at least one of: (i) an error at an onset of the singing sound; (ii) a duration of sound output; (iii) an inflection of the singing sound; or (iv) a timbre change of the singing sound.

In a specific example (Aspect 16) according to Aspects 1, the sound processing method further includes providing the trained model, in which, the trained model includes a plurality of musical instrument sound models, each corresponding to a different musical instrument, the input data is input to a musical instrument sound model that corresponds to a musical instrument selected from among the plurality of musical instrument sound models, and the sound data represents musical instrument sound of the selected musical instrument.

According to this aspect, the sound data can be generated using any of the musical instrument sound models. As a result, a variety of musical instrument sounds that correlate with singing sounds of the user U can be generated.

A sound processing system according to one aspect (Aspect 17) of this disclosure includes: at least one memory storing a program; and at least one processor that implements the program to: generate singing sound data based on a sound signal representing singing sound; and generate sound data representing musical instrument sound that correlates with musical elements of the singing sound, by inputting input data that includes the singing sound data to a trained model that has learned, by machine learning, a relationship between singing sound for training and musical instrument sound for training.

In a specific example (Aspect 18) according to Aspect 17, the sound processing system further includes the trained model. The singing data includes: (i) first data including: a pitch of the singing sound; and an onset of the singing sound; and (ii) second data including a feature that relates to the singing sound and differs from the pitch and onset of the singing sound. The trained model includes: (i) a first model that outputs third data in response to receipt of first intermediate data that includes the first data, the third data including: (a) a pitch of the musical instrument sound; and (b) an onset of the musical instrument sound, and (ii) a second model that outputs the sound data in response to receipt of second intermediate data that includes the second data and the third data.

An electronic musical instrument according to one aspect (Aspect 19) of this disclosure includes: at least one memory storing a program; and at least one processor that implements the program to: generate singing sound data based on a sound signal representing singing sound; generate sound data representing musical instrument sound that correlates with musical elements of the singing sound, by inputting input data that includes the singing sound data to a trained model that has learned, by machine learning, a relationship between singing sound for training and musical instrument sound for training; and control a sound emitting device to emit performance sound of a piece of music, and musical instrument sound represented by the sound data.

The “performance sound of a piece of music” means a performance sound represented by performance data that is provided in advance, or a performance sound of a user (e.g., singer or another player). The singing sound may be emitted by the sound emitting device in addition to the musical instrument sound and the performance sound.

A recording medium according to one aspect (Aspect 20) of this disclosure is a non-transitory computer readable recording medium storing a program executable by at least one processor to execute a method comprising: generating singing sound data based on a sound signal representing singing sound; and generating sound data representing musical instrument sound that correlates with musical elements of the singing sound, by inputting input data that includes the singing sound data to a trained model that has learned, by machine learning, a relationship between singing sound for training and musical instrument sound for training.

### DESCRIPTION OF REFERENCES SIGNS

100: electronic musical instrument, 10: musical keyboard, 11: controller, 12: storage device, 13: input device, 14: sound emitting device, 15: sound receiving device, 17: communication device, 21: selector, 22: sound processor, 23: performance sound generator, 24: output controller, 31: first generator, 32: second generator. M: trained model, M1: first model, M2: second model, 50: machine learning system, 51: controller, 52: storage device, 53: communication device, 61: acquisition section, 62: learning section, and 63: distribution section.

What is claimed is:

1. A computer-implemented sound processing method comprising:
outputting singing sound data based on a sound signal representing singing sound; and
outputting sound data representing musical instrument sound that correlates with musical elements of the singing sound, by inputting input data that includes the singing sound data to a trained model that has learned, by machine learning, a relationship between singing sound for training and musical instrument sound for training.

2. The sound processing method according to claim 1, wherein the outputting outputs the sound data in parallel with progress of the singing sound.

3. The sound processing method according to claim 1, wherein the sound data represents a pitch of the musical instrument sound that changes in accordance with a pitch of the singing sound.

4. The sound processing method according to claim 1, wherein the sound data represents a pitch of the musical instrument sound that satisfies a relationship where a predetermined pitch difference exists between the pitch of the musical instrument sound and a pitch of the singing sound.

5. The sound processing method according to claim 1, wherein the input data includes known sound data output by the trained model.

6. The sound processing method according to claim 1, wherein:
the input data includes musical instrument data that specifies a first musical instrument from among a plurality of musical instruments, and
the sound data represents musical instrument sound of the first musical instrument specified by the musical instrument data.

7. The sound processing method according to claim 6, further comprising adding the following signals:
the sound signal representing the singing sound;
a time series signal of the sound data; and
a signal representing musical instrument sound of a second musical instrument that differs from the first musical instrument.

8. The sound processing method according to claim 1, wherein:
the singing sound data includes a plurality of features relating to the singing sound, and
the plurality of features include:
a pitch of the singing sound; and
an onset of the singing sound.

9. The sound processing method according to claim 1, further comprising:
providing the trained model,
wherein the singing data includes:
first data including:
a pitch of the singing sound; and
an onset of the singing sound; and
second data including a feature that relates to the singing sound and differs from the pitch and onset of the singing sound, and
wherein the trained model includes:
a first model that outputs third data in response to receipt of first intermediate data that includes the first data, the third data including:
a pitch of the musical instrument sound; and
an onset of the musical instrument sound, and
a second model that outputs the sound data in response to receipt of second intermediate data that includes the second data and the third data.

10. The sound processing method according to claim 1, further comprising:
providing the trained model,
wherein the singing data includes:
first data including:
a pitch of the singing sound; and
an onset of the singing sound;
second data including a feature that relates to the singing sound and differs from the pitch and onset of the singing sound,
wherein the trained model includes:
a first model that outputs third data in response to receipt of first intermediate data that includes the first data, the third data including:
a pitch of the musical instrument sound; and
an onset of the musical instrument sound, and
a second model that outputs fourth data in response to receipt of second intermediate data that includes the second data and the third data, the fourth data including a feature that relates to the musical instrument sound and differs from the pitch and onset of the singing sound, and
the sound data includes the third data and the fourth data.

11. The sound processing method according to claim 9, wherein the first intermediate data includes musical instrument data that specifies a musical instrument.

12. The sound processing method according to claim 11, wherein the second intermediate data includes the musical instrument data.

13. The sound processing method according to claim 9, wherein the first intermediate data includes known sound data.

14. The sound processing method according to claim 9, wherein the second intermediate data includes known sound data.

15. The sound processing method according to claim 8, wherein the plurality of features further include at least one of:
an error at an onset of the singing sound;
a duration of sound output;
an inflection of the singing sound; or
a timbre change of the singing sound.

16. The sound processing method according to claim 1, further comprising:
providing the trained model,
wherein the trained model includes a plurality of musical instrument sound models, each corresponding to a different musical instrument,
the input data is input to a musical instrument sound model that corresponds to a musical instrument selected from among the plurality of musical instrument sound models, and
the sound data represents musical instrument sound of the selected musical instrument.

17. A sound processing system comprising:
at least one memory storing a program; and
at least one processor that implements the program to:
output singing sound data based on a sound signal representing singing sound; and
output sound data representing musical instrument sound that correlates with musical elements of the singing sound, by inputting input data that includes the singing sound data to a trained model that has learned, by machine learning, a relationship between singing sound for training and musical instrument sound for training.

18. The sound processing system according to claim 17, further comprising:
the trained model,
wherein the singing data includes:
first data including:
a pitch of the singing sound; and
an onset of the singing sound; and
second data including a feature that relates to the singing sound and differs from the pitch and onset of the singing sound, and
wherein the trained model includes:
a first model that outputs third data in response to receipt of first intermediate data that includes the first data, the third data including:
a pitch of the musical instrument sound; and
an onset of the musical instrument sound, and
a second model that outputs the sound data in response to receipt of second intermediate data that includes the second data and the third data.

19. An electronic musical instrument comprising:
at least one memory storing a program; and
at least one processor that implements the program to:
output singing sound data based on a sound signal representing singing sound;
output sound data representing musical instrument sound that correlates with musical elements of the singing sound, by inputting input data that includes the singing sound data to a trained model that has learned, by machine learning, a relationship between singing sound for training and musical instrument sound for training; and
control a sound emitting device to emit performance sound of a piece of music, and musical instrument sound represented by the sound data.

20. A non-transitory computer readable recording medium storing a program executable by at least one processor to execute a method comprising:
outputting singing sound data based on a sound signal representing singing sound; and
outputting sound data representing musical instrument sound that correlates with musical elements of the singing sound, by inputting input data that includes the singing sound data to a trained model that has learned, by machine learning, a relationship between singing sound for training and musical instrument sound for training.
